(19) United States
(12) Patent Application Publication
(10) Pub. No.: US 2024/0349400 A1
(43) Pub. Date: Oct. 17, 2024

(54) AMPLITUDE MODULATION OF VOLTAGE WITH RECTIFIER AND BUCK STAGE TO CONTROL HEATER TEMPERATURE

(71) Applicant: LAM RESEARCH CORPORATION, Fremont, CA (US)

(72) Inventors: Reshmi Chethanamkurissi VARIATH, Bangalore (IN); Rand Arthur CONNER, Beaverton, OR (US)

(21) Appl. No.: 18/681,597

(22) PCT Filed: Jul. 28, 2022
(86) PCT No.: PCT/US2022/038633

§ 371 Date: Feb. 6, 2024

Related U.S. Application Data
(60) Provisional application No. 63/231,942, filed on Aug. 11, 2021.

(51) Int. Cl. H05B 1/02; H02M 7/217

(52) U.S. Cl. CPC H05B 1/0202; H02M 7/217

(57) ABSTRACT

A control circuit for a resistive heater includes a rectifier configured to receive an AC signal from an AC source. A switch is connected to the rectifier. A first diode is connected to the switch and the rectifier. An LC circuit is connected to the switch, the first diode and a resistive heater. A thermocouple is configured to generate a temperature signal based on a temperature of the resistive heater. A switch controller is configured to receive the temperature signal from the thermocouple and generate a switch control signal configured to control a duty cycle of the switch to vary power output to the LC circuit. The LC circuit outputs a rectified AC signal having an amplitude that varies based on a duty cycle of the switch.

### CROSS-REFERENCE TO RELATED APPLICATIONS

This application claims the benefit of U.S. Provisional Application No. 63/231,942, filed on Aug. 11, 2021. The entire disclosure of the application referenced above is incorporated herein by reference.

### FIELD

The present disclosure relates to heaters and more particularly to amplitude modulation of heaters.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Resistive heaters may be used in a variety of applications. For example, substrate processing systems are typically used to perform treatments on substrates such as semiconductor wafers. During treatment, the substrate is arranged on a substrate support in a processing chamber. Examples of substrate treatments include deposition, etching, cleaning and/or other processes. Process gas mixtures are supplied. RF plasma power may be used to ignite the process gases to cause chemical reactions.

Temperature variations of process gases, processing chamber components, and/or the substrate during substrate processing may cause process non-uniformity. For example, deposition onto an exposed surface of the substrate may increase or decrease with temperature variation, which leads to non-uniform deposition thicknesses on the substrate. To ensure process uniformity, a temperature of the process gases, processing chamber components, and/or the substrate may be controlled using one or more resistive heaters.

### SUMMARY

A control circuit for a resistive heater includes a rectifier configured to receive an AC signal from an AC source. A switch is connected to the rectifier. A first diode is connected to the switch and the rectifier. An LC circuit is connected to the switch, the first diode and a resistive heater. A thermocouple is configured to generate a temperature signal based on a temperature of the resistive heater. A switch controller is configured to receive the temperature signal from the thermocouple and generate a switch control signal configured to control a duty cycle of the switch to vary power output to the LC circuit. The LC circuit outputs a rectified AC signal having an amplitude that varies based on a duty cycle of the switch.

In some embodiments, the rectifier includes a second diode and a third diode. Anodes of the second and third diodes are connected to a first terminal of the AC source. The rectifier includes a fourth diode and a fifth diode. Cathodes of the fourth and fifth diodes are connected to a second terminal of the AC source.

In some embodiments, the switch includes a first terminal connected to the rectifier and the first diode includes a cathode connected to a second terminal of the switch. The LC circuit includes a first inductor including a first terminal connected to a second terminal of the switch and a cathode of the first diode, a second inductor including a first terminal connected to an anode of the first diode and the rectifier and a capacitor including a first terminal connected to a second terminal of the first inductor and a first terminal of the resistive heater and a second terminal connected to a second terminal of the second inductor and a second terminal of the resistive heater.

In some embodiments, the switch controller includes a setpoint generator configured to generate a setpoint signal. The switch controller further includes a summer including a noninverting input configured to receive the setpoint signal and an inverting input configured to receive a signal based on the temperature signal. The switch controller further includes a feedback conditioner configured to receive the temperature signal, to condition the temperature signal and to output a conditioned temperature signal to the summer.

In some embodiments, the switch controller includes a proportional integral derivative (PID) controller configured to receive an output of the summer and to generate a PID signal. A digital to analog converter is configured to generate a voltage threshold based on the PID signal. A comparator including a noninverting input configured to receive the voltage threshold and an inverting input is configured to receive an output of an oscillator, wherein an output of the comparator drives the switch.

A control circuit for a resistive heater includes a rectifier configured to rectify a 3-phase AC signal and N heater circuits, where N is an integer greater than zero. Each of the N heater circuits includes a switch connected to the rectifier, a first diode connected to the switch and the rectifier, an LC circuit connected to the switch, the first diode and a resistive heater. A thermocouple is configured to generate a temperature signal based on a temperature of the resistive heater. A switch controller is configured to receive the temperature signal from the thermocouple and generate a switch control signal configured to control the switch to vary power output to the LC circuit. The LC circuit outputs a rectified AC signal having an amplitude that varies based on a duty cycle of the switch.

In some embodiments, the switch includes a first terminal connected to the rectifier and the first diode includes a cathode connected to a second terminal of the switch.

In some embodiments, the LC circuit includes a first inductor including a first terminal connected to a second terminal of the switch and a cathode of the first diode; a second inductor including a first terminal connected to an anode of the first diode and the rectifier; and a capacitor including a first terminal connected to a second terminal of the first inductor and a first terminal of the resistive heater and a second terminal connected to a second terminal of the second inductor and a second terminal of the resistive heater.

In some embodiments, the switch controller includes a setpoint generator configured to generate a setpoint signal; and a summer including a noninverting input configured to receive the setpoint signal and an inverting input configured to receive a signal based on the temperature signal.

In some embodiments, the switch controller further includes a feedback conditioner configured to receive the temperature signal, to condition the temperature signal and to output a conditioned temperature signal to the summer. The switch controller includes a proportional integral derivative (PID) controller configured to receive an output of the summer and to generate a PID signal. A digital to analog converter is configured to generate a voltage threshold based on the PID signal. A comparator including a noninverting input configured to receive the voltage threshold and an inverting input is configured to receive an output of an oscillator, wherein an output of the comparator drives the switch. N is greater than one.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram and electrical schematic of an example of a heater control circuit;

FIG. 2 is a graph illustrating an ideal response of a resistive heater;

FIG. 3A is a graph illustrating voltage waveforms that are generated during phase angle control;

FIG. 3B is a graph illustrating voltage waveforms that are generated during burst control;

FIG. 4 is a functional block diagram and electrical schematic of an example of a heater control circuit according to the present disclosure;

FIG. 5 is a graph of voltage as a function of time for an oscillating signal, a rectified oscillating signal and a pulsed signal according to the present disclosure;

FIG. 6 is a graph of an example of a switched rectified voltage as a function of time according to the present disclosure;

FIG. 7 is a graph showing of an example a PWM signal generated using a triangular wave and a voltage threshold;

FIG. 8 shows an example of a switched rectified AC voltage as a function of time for various duty cycles according to the present disclosure;

FIG. 9 is a functional block diagram of an example a heater control circuit using a 3-phase AC source according to the present disclosure;

FIGS. 10A and 10B are functional block diagrams of examples of a rectifier according to the present disclosure;

FIG. 11 is a functional block diagram of an example of a controller and DC-DC converter for the heater control circuit of FIG. 9;

FIG. 12 is graph of an example of a rectified AC signal; and

FIG. 13 is a graph of an example of a rectified 3-phase signal.

In the drawings, reference numbers may be reused to identify similar and/or identical elements.

### DETAILED DESCRIPTION

Heater temperature can be controlled by adjusting the on time of a heater. The on time of the heater adjusts the root mean square (RMS) voltage and current through the heater. When the power to the heater is turned ON and OFF continuously, the heater goes through a thermal excursion. The heater heats up during ON time and cools down during OFF time.

The cycling ON and OFF causes the heater to expand and contract continuously in line with the power on/off, which adversely impacts the reliability of the heater. In addition, some heaters have a large difference between the cold and hot resistance, which causes high inrush current (many times of the steady state current) when the heater is turned ON. The inrush current lasts for seconds and causes stress to the system and components.

Heater control circuits according to the present disclosure modulate the heater voltage amplitude instead of ON time to prevent the heater from turning on and off. Voltage changes gradually as the temperature requirement changes. As a result, there is no continuous expansion and contraction as in on/off control. Heater voltage starts from very low voltage to limit the inrush current and slowly builds up as the heater resistance increases.

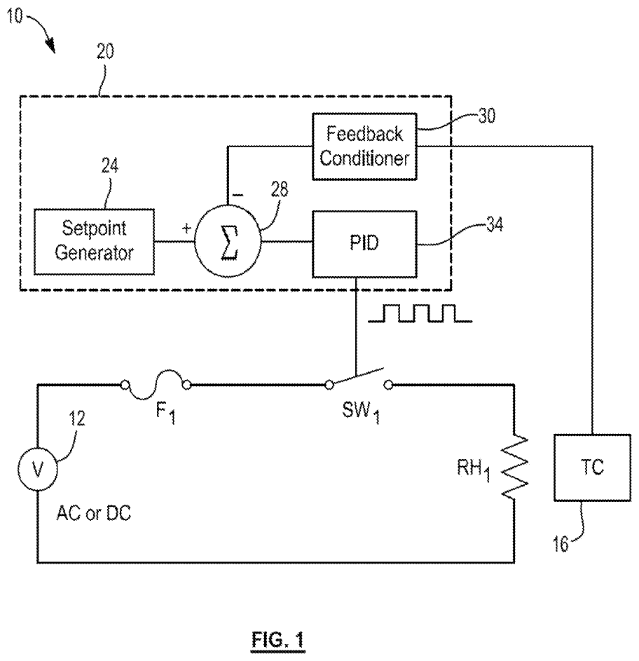

Referring now to FIG. 1, a heater control circuit 10 includes a voltage source 12 configured to supply alternating current (AC) or direct current (DC) voltage. The voltage source 12 is connected by a fusible link F₁ (such as a circuit breaker (CB) or fuse) to a switch SW1 connected to a resistive heater RH₁. A thermocouple (TC) 16 senses a temperature of the resistive heater RH₁ and generates a temperature feedback signal.

A switch control circuit 20 includes a setpoint generator 24 that generates and outputs a voltage setpoint signal based on a desired temperature to a noninverting input of a summer 28. The temperature feedback signal from the TC 16 is received by feedback conditioner 30. The feedback conditioner 30 conditions the temperature feedback signal and outputs a conditioned temperature feedback signal to an inverting input of the summer 28. In some examples, the feedback conditioner 30 adjusts a scale of the temperature feedback signal to a scale of the temperature setpoint signal and/or performs filtering and/or smoothing of the signal.

An output of the summer 28 is input to a proportional integral derivative (PID) controller 34. An output of the PID controller 34 controls opening and closing of the switch SW1. In some examples, the switch SW₁ includes an electromagnetic relay, a solid-state relay, a silicon controlled rectifier (SCR) or other switching device.

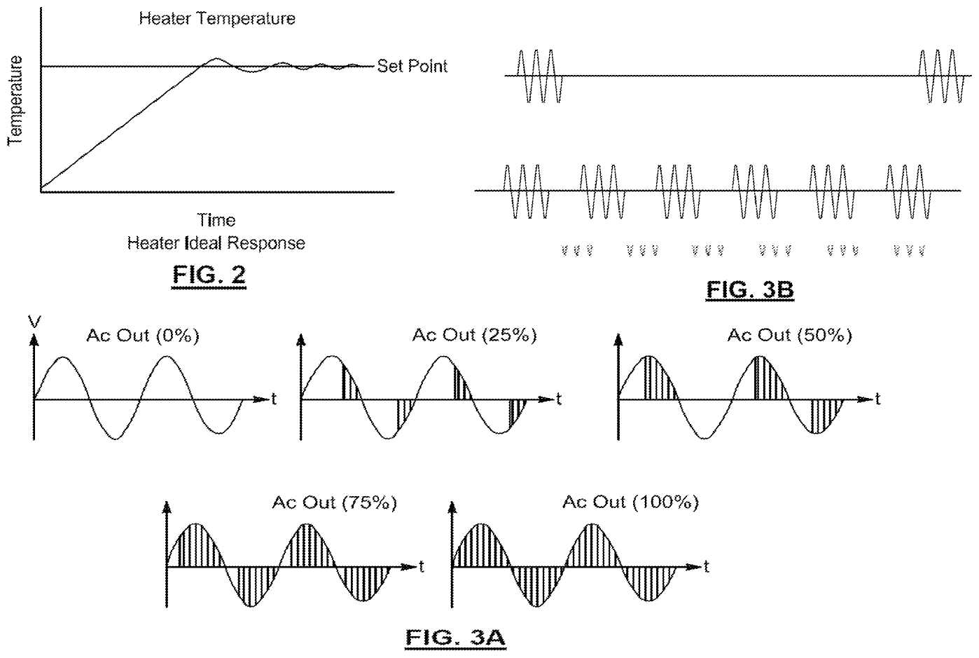

Referring now to FIG. 2, heater temperature is shown as a function of time for an ideal heater. The heater temperature increases relatively quickly to the setpoint temperature and settles at the setpoint temperature while minimizing overshoot and undershoot.

For resistive heaters, the heat that is generated to cause the temperature increase is proportional to the power loss in the resistive heater. The power loss is equal to I²R or V²/R where V is the root mean square (RMS) voltage across the resistive heater, I is the RMS current flowing through the resistive heater and R is the resistance of the resistive heater.

Heater temperature is traditionally controlled by controlling the on time of the resistive heater and thereby controlling the RMS voltage and current through the resistive heater. This is achieved by turning the heater power on and off for specific on and off times using the switch SW₁ and pulse width modulation at the required duty cycle. The required on time is calculated using the PID controller 34.

When the power to the heater is cycled on and off, the resistive heater goes through a thermal excursion. The resistive heater heats up when the switch SW₁ is on and cools down when the switch SW₁ is off. The cycling on and off causes the resistive heater to expand and contract repeatedly with the power on/off and causes stress in the resistive heater, which impacts reliability. Increased wear can be exacerbated when the resistive heater is turned on and off repeatedly. When the on time is shorter, it takes longer to meet the changes in the temperature set point and the number of on/off cycles increases.

Some resistive heaters have a lower cold resistance as compared to a hot resistance. The lower cold resistance causes a high inrush current which gradually reduces once the resistance increases at higher temperatures. The inrush current lasts for seconds (unlike capacitive or transformer inrush currents that last for shorter periods in the millisecond range) until the temperature of the resistive heater increases to a higher value. The high inrush current stresses components of the temperature control circuit and the resistive heater. The higher inrush current also has an adverse impact on upstream components such as fuses, contactors and other components that need to be rated to withstand the high inrush current.

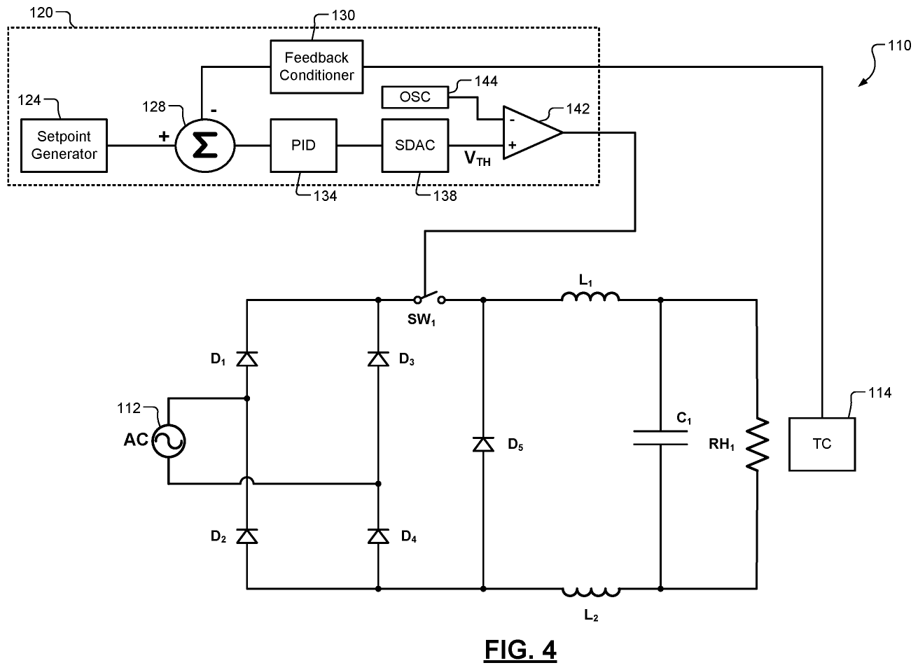

Referring now to FIGS. 3A and 3B, phase angle firing control and burst control are two types of on/off switching that have been used. When using phase angle firing control, the switch SW₁ is closed at specific phase angles from zero crossing to achieve the required on time as shown in FIG. 3A. The output is proportional to the on time. The on-time can vary from 0 to 1 line cycle period. This approach reduces inrush current in the heaters with high variations between cold and hot resistance. However, this approach causes high electromagnetic interference (EMI) because switching is performed at non-zero voltages. This approach also causes high switching losses due to heating in the switching device because both current and voltage are high during turn on time.

When using burst control, switching is performed at zero crossing of the line voltage as shown in FIG. 3B. The number of cycles that the switch SW₁ remains on depends upon the duty cycle and the remaining cycles are off. Minimum on-time is one cycle. Therefore, current limiting is not possible. There is no EMI because the switching is performed at the zero crossing. The burst control approach increases the life of the switch SW₁ because switching is performed less often and occurs at the zero crossing, which corresponds to low losses and heating. However, the life of the resistive heater can be adversely impacted if the time base is longer than three cycles, which limits the range of the duty cycle ratio.

For both of these control approaches, the resistive heater can see non-uniform voltage transitions between zero and input voltage. Full load input current is present when the switch is closed and no current when the switch is open. Thermal excursions are difficult to eliminate because the heater is powered on and off in each cycle.

In the heater control circuit according to the present disclosure, the amplitude of the voltage is varied based on the duty cycle (instead of on time). Therefore, the resistive heater does not experience abrupt on/off cycling. The resistive heater will see more smooth and seamless transitions instead of repeated on and off cycles, which eliminates thermal excursions. The resistive heater can respond to the changes in the temperature set point more quickly because the voltage can be varied seamlessly and quickly. This also helps to limit the inrush current as the voltage can be built up gradually without the need for phase angle firing. Voltage and current can be limited to protect short circuits or overcurrent through fold-back.

Referring now to FIG. 4, a heater control circuit 110 is shown to include a voltage source 112 that provides an AC voltage at a predetermined frequency. In some examples, the frequency of the voltage source 112 is 50 Hz or 60 Hz, although other frequencies can be used. A first terminal of the voltage source 112 is connected to an anode of a diode D1 and a cathode of a diode D2. A second terminal of the voltage source 112 is connected to an anode of a diode D3 and a cathode of a diode D4.

Cathodes of the diodes D1 and D3 are connected to a first terminal of a switch SW1. A second terminal of the switch SW₁ is connected to a cathode of a diode Ds and a first terminal of a first inductor L₁. A second terminal of the inductor L₁ is connected to a first terminal of a capacitor C₁ and a first terminal of a resistive heater RH₁. A second terminal of the capacitor C₁ and a second terminal of the resistive heater RH₁ are connected to a first terminal of a second inductor L₂. A second terminal of the second inductor L₂ is connected to anodes of the diodes D₂, D₄, and D₅. A thermocouple 114 generates a heater temperature signal.

A control circuit 120 includes a setpoint generator 124 that generates a set point signal that is output to a noninverting input of a summer 128. A feedback conditioner 130 receives the heater temperature signal from the thermocouple 114. A conditioned temperature feedback signal that is output by the feedback conditioner 130 is input to an inverting input of the summer 128.

An output of the summer 128 is input to a PID controller 134. An output of the PID controller 134 is input to a digital to analog converter (DAC) or a serial digital to analog converter (SDAC) 138. The SDAC 138 outputs a voltage threshold to a noninverting input of the comparator 142. An oscillator 144 outputs an oscillating signal to an inverting input of the comparator 142. An output of the comparator 142 controls the switch SW1.

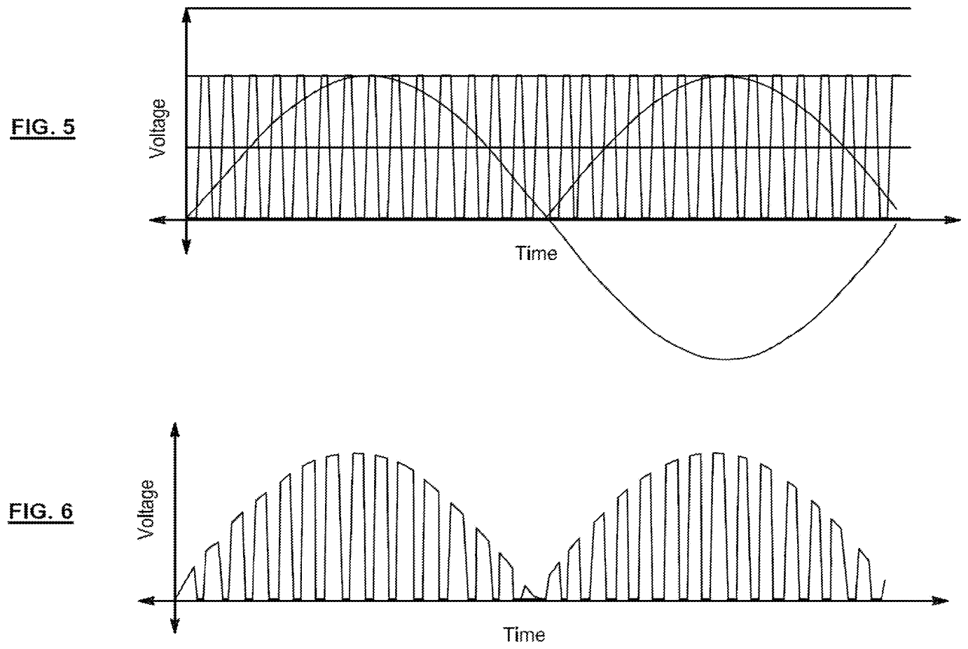

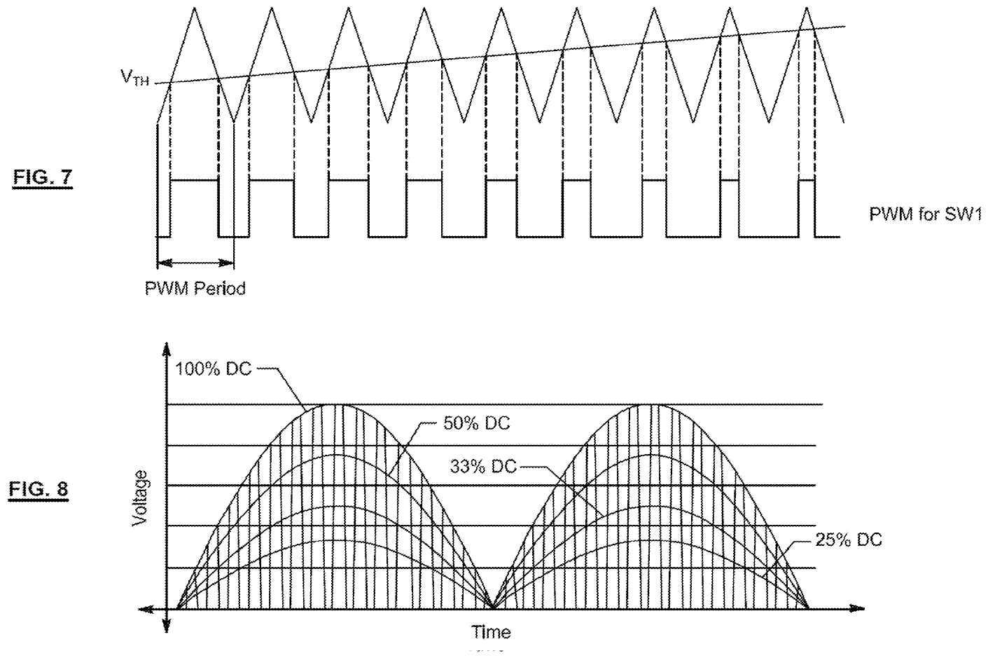

Referring now to FIGS. 5 to 8, operation of the circuit in FIG. 4 is shown. An input rectifier including diodes D₁, D₂, D₃ and D₄ rectifies the input AC voltage as shown in FIG. 5. The switch SW₁ is controlled by a pulse width modulation (PWM) which is translated from the output of the PID controller as shown in FIG. 7. In some examples, the switching frequency of the PWM is significantly higher than the frequency of the voltage source. In some examples, the switching frequency is 100, 250, 500 or 1000 times the frequency of the voltage source.

The PWM signal contains the same duty cycle as in the output of the PID controller but is amplified into high-frequency. The on-time of the PWM is the same as the on-time generated by the PID controller. The PID output duty cycle is slower as compared to the frequency of the AC source and normally constant throughout one half cycle. The filtered output of the switched rectifier is directly proportional to the PID duty cycle.

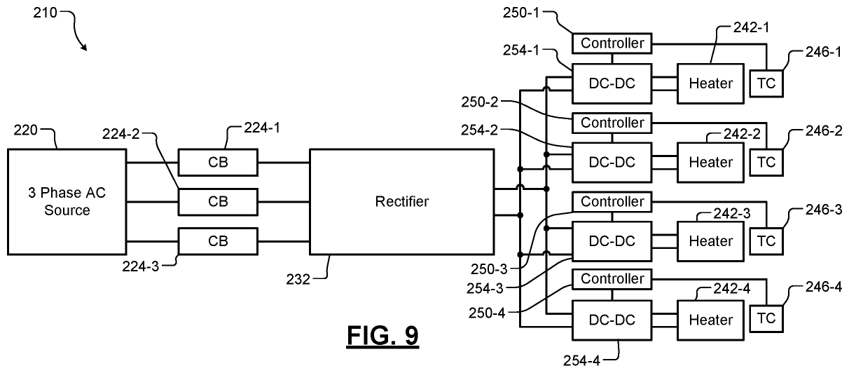

In some examples, the LC filter is small enough to filter out only the high switching frequency component of the switched rectifier output and retains the frequency of the rectified voltage. In some examples, the LC filter filters the switching frequency of 50 KHz and passes the frequency of the rectified voltage (for example, 100 Hz or 2×50 Hertz since the voltage source is rectified). If the PID duty cycle is 25%, 33%, 50% or 100%, then the output voltage is 25%, 33%, 50% or 100%, respectively, of the input voltage as shown in FIG. 8.

While a specific topology is shown above, other topologies can be used. For example, a switched rectifier using insulated gate bipolar transistors (IGBT) can also be used. In other examples, back-to-back MOSFETs can be used instead of the upper diodes. In still other examples, AC or DC chopper circuits can be used to implement the same logic. In other words, the circuit according to the present disclosure generates a switched rectifier output with high switching frequency and same duty ratio as the PID output.

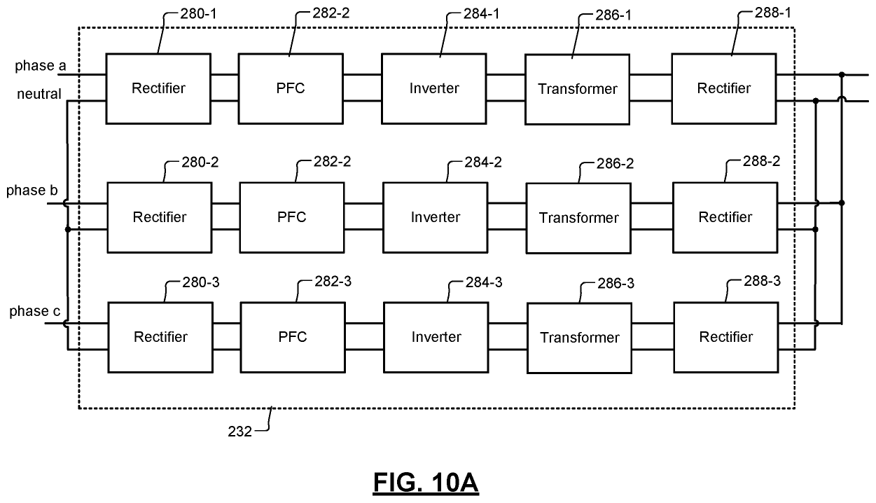

Referring now to FIG. 9, another heater control circuit 210 is shown. A three-phase AC voltage source 220 provides outputs to circuit breakers 224-1, 224-2 and 224-3, respectively (collectively circuit breakers 224). Outputs of the circuit breakers 224 are input to a rectifier 232.

First and second outputs of the rectifier 232 are input to DC-DC converters 254-1, 254-2, 254-3, and 254-4 (collectively DC-DC converters 254). Outputs of the DC-DC converters 254-1, 254-2, 254-3, and 254-4 are input to heaters 242-1, 242-2, 242-3 and 242-4, respectively (collectively heaters 242). The function of the output DC-DC stage is to modulate the amplitude of rectified 3 phase voltage to a voltage corresponding to the required temperature of the heaters 242. In some examples, this stage can include a simple buck stage with an LC filter to filter out the switching frequency. Thermocouples 246-1, 246-2, 246-3 and 246-4 (collectively thermocouples 246) generate a measured temperature signals that are fed back to controllers 250-1, 250-2, 250-3, and 250-4 (collectively controllers 250) that control the DC-DC converters 254-1, 254-2, 254-3, and 254-4, respectively.

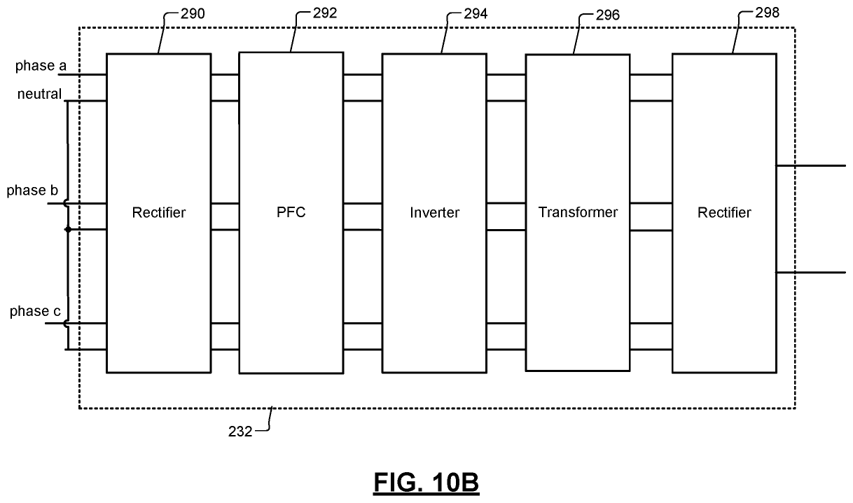

Referring now to FIG. 10A, an example of the rectifier 232 is further configured to perform power factor correction and isolation. The rectifier 232 includes a first rectifier circuit 280-1 that is connected to one phase and neutral and that includes a plurality of diodes. A power factor correction (PFC) circuit 282-1 receives an output of the first rectifier circuit 280-1 and performs power factor correction. In some examples, the PFC circuit 282-1 performs boost power factor correction and includes an inductor having a second terminal connected to a cathode of a diode, a switch having a first terminal connected between the second terminal of the inductor and the cathode of the diode, and a capacitor connected to an anode of the diode, although other power factor correction circuits can be used.

An inverter 284-1 receives an output of the PFC circuit 282-1. In some examples, the inverter 284-1 includes an H-bridge inverter. An output of the inverter 284-1 is input to a transformer 286-1 that provides isolation. An output of the transformer 286-1 is input to a rectifier 288-1. Other phases are designed similarly and are connected to rectifiers 280-2 and 280-3, PFC circuits 282-2 and 282-3, inverters 284-2 and 284-3, transformers 286-2 and 286-3, and rectifiers 288-2 and 288-3, respectively.

Separate rectifiers, PFC circuits, inverters, transformers and rectifiers are provided for each of the three phases as shown in FIG. 10A. Alternatively, a rectifier 290, a PFC circuit 292, an inverter 294, a transformer 296 and a rectifier 298 that handle three phases can be provided as shown in FIG. 10B.

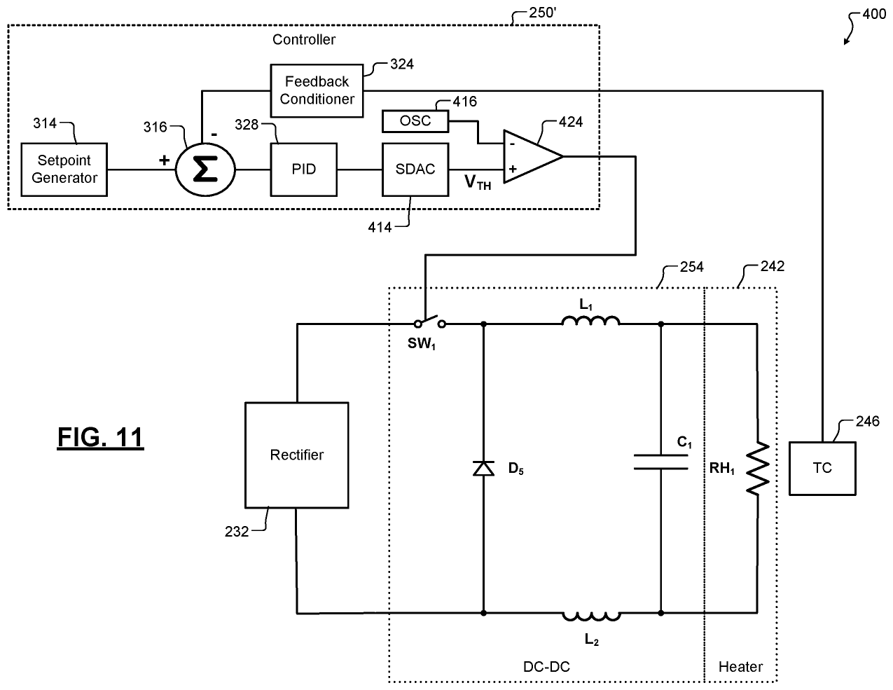

Referring now to FIG. 11, one of the DC-DC converters 254 is shown to include a switch SW₁ including a first terminal connected to the rectifier and a second terminal connected to a cathode of a diode D₅ and a first terminal of an inductor L₁. A second terminal of the inductor L₁ is connected to a first terminal of a capacitor C₁ and a first terminal of a resistive heater RH₁ or 242. A second terminal of the resistive heater RH₁ and a second terminal of the capacitor C₁ are connected to a first terminal of a second inductor L₂. Second terminal of the inductor L₂ is connected to the anode of the diode D₅ and to the rectifier 232.

The controller 250 includes a setpoint generator 314 that generates a set point signal that is output to a noninverting input of a summer 316. A feedback conditioner 324 receives an output of the thermocouple 246 and outputs a condition temperature feedback signal to an inverting input of the summer 316. An output of the summer 316 is input to a PID controller 328. An output of the PID controller 328 is input to a DAC or

SDAC controller 414, which generates and outputs a voltage threshold to a noninverting input of a comparator 424. An oscillator 416 outputs an oscillating signal to an inverting input of the comparator 424. An output of the comparator 424 drives the switch SW₁.

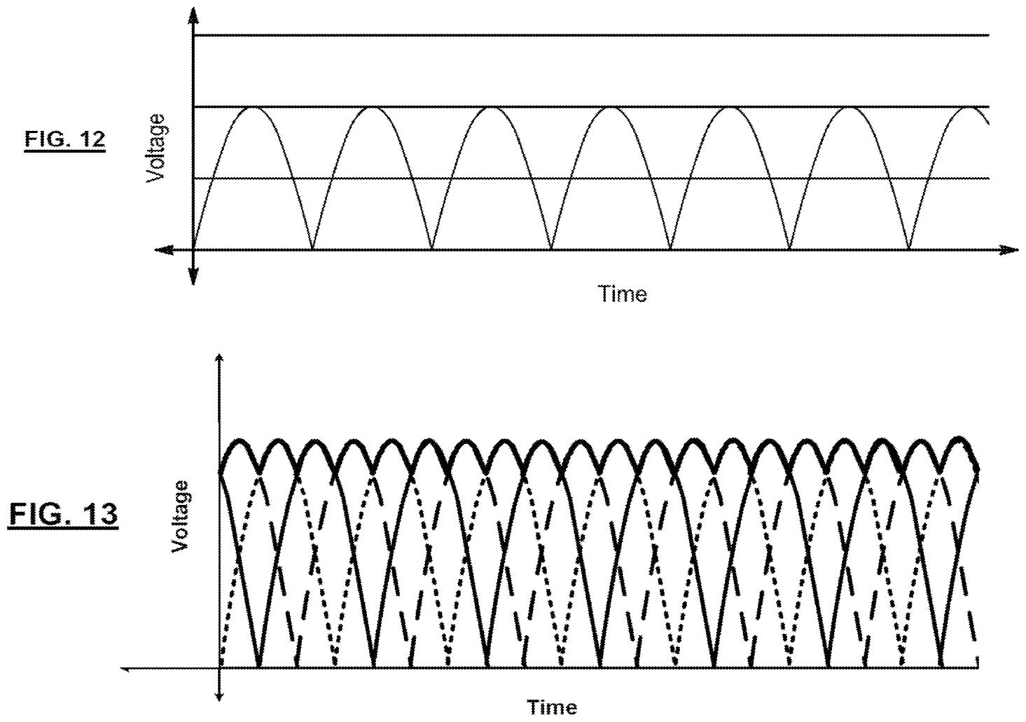

Referring now to FIGS. 12 and 13, voltage waveforms are shown. In FIG. 12, a rectified voltage for a single phase is shown. In FIG. 12, a three-phase rectified voltage is shown.

As can be appreciated, the heater control circuit described herein increase the reliability of resistive heaters and reduce stress on other components of the heater control circuit. The heater control circuit can be used for resistive heaters in a wide variety of applications such as pedestal heaters, gas heaters, showerhead heaters, and/or other resistive heating in semiconductor applications. The heater control circuit described herein may also be used in other applications such as industrial furnaces, ovens or other applications where temperature is precisely controlled with a PID.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain embodiments, any one or more of those embodiments described with respect to any embodiment of the disclosure can be implemented in and/or combined with embodiments of any of the some embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g. a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

What is claimed is:

1. A control circuit for a resistive heater, comprising:
a rectifier configured to receive an AC signal from an AC source;
a switch connected to the rectifier;
a first diode connected to the switch and the rectifier; and
an LC circuit connected to the switch, the first diode and a resistive heater;
a thermocouple configured to generate a temperature signal based on a temperature of the resistive heater; and
a switch controller configured to:
receive the temperature signal from the thermocouple; and
generate a switch control signal configured to control a duty cycle of the switch to vary power output to the LC circuit,
wherein the LC circuit outputs a rectified AC signal having an amplitude that varies based on a duty cycle of the switch.

2. The control circuit of claim 1, wherein the rectifier includes:
a second diode;
a third diode, wherein anodes of the second and third diodes are connected to a first terminal of the AC source;
a fourth diode; and
a fifth diode, wherein cathodes of the fourth and fifth diodes are connected to a second terminal of the AC source.

3. The control circuit of claim 1, wherein:
the switch includes a first terminal connected to the rectifier; and
the first diode includes a cathode connected to a second terminal of the switch.

4. The control circuit of claim 1, wherein the LC circuit includes:
a first inductor including a first terminal connected to a second terminal of the switch and a cathode of the first diode;
a second inductor including a first terminal connected to an anode of the first diode and the rectifier; and
a capacitor including a first terminal connected to a second terminal of the first inductor and a first terminal of the resistive heater and a second terminal connected to a second terminal of the second inductor and a second terminal of the resistive heater.

5. The control circuit of claim 1, wherein the switch controller includes a setpoint generator configured to generate a setpoint signal.

6. The control circuit of claim 5, wherein the switch controller further includes a summer including a noninverting input configured to receive the setpoint signal and an inverting input configured to receive a signal based on the temperature signal.

7. The control circuit of claim 6, wherein the switch controller further includes a feedback conditioner configured to receive the temperature signal, to condition the temperature signal and to output a conditioned temperature signal to the summer.

8. The control circuit of claim 6, wherein the switch controller includes a proportional integral derivative (PID) controller configured to receive an output of the summer and to generate a PID signal.

9. The control circuit of claim 8, further comprising a digital to analog converter configured to generate a voltage threshold based on the PID signal.

10. The control circuit of claim 9, further comprising a comparator including a noninverting input configured to receive the voltage threshold and an inverting input configured to receive an output of an oscillator, wherein an output of the comparator drives the switch.

11. A control circuit for a resistive heater, comprising:
a rectifier configured to rectify a 3-phase AC signal; and
N heater circuits, where N is an integer greater than zero,
wherein each of the N heater circuits includes:
a switch connected to the rectifier;
a first diode connected to the switch and the rectifier;
an LC circuit connected to the switch, the first diode and a resistive heater;
a thermocouple configured to generate a temperature signal based on a temperature of the resistive heater; and
a switch controller configured to:
receive the temperature signal from the thermocouple; and
generate a switch control signal configured to control the switch to vary power output to the LC circuit,
wherein the LC circuit outputs a rectified AC signal having an amplitude that varies based on a duty cycle of the switch.

12. The control circuit of claim 11, wherein:
the switch includes a first terminal connected to the rectifier; and
the first diode includes a cathode connected to a second terminal of the switch.

13. The control circuit of claim 11, wherein the LC circuit includes:
a first inductor including a first terminal connected to a second terminal of the switch and a cathode of the first diode;
a second inductor including a first terminal connected to an anode of the first diode and the rectifier; and
a capacitor including a first terminal connected to a second terminal of the first inductor and a first terminal of the resistive heater and a second terminal connected to a second terminal of the second inductor and a second terminal of the resistive heater.

14. The control circuit of claim 11, wherein the switch controller includes:
a setpoint generator configured to generate a setpoint signal; and
a summer including a noninverting input configured to receive the setpoint signal and an inverting input configured to receive a signal based on the temperature signal.

15. The control circuit of claim 14, wherein the switch controller further includes a feedback conditioner configured to receive the temperature signal, to condition the temperature signal and to output a conditioned temperature signal to the summer.

16. The control circuit of claim 14, wherein the switch controller includes a proportional integral derivative (PID) controller configured to receive an output of the summer and to generate a PID signal.

17. The control circuit of claim 16, further comprising a digital to analog converter configured to generate a voltage threshold based on the PID signal.

18. The control circuit of claim 17, further comprising a comparator including a noninverting input configured to receive the voltage threshold and an inverting input configured to receive an output of an oscillator, wherein an output of the comparator drives the switch.

19. The control circuit of claim 11, wherein N is greater than one.
